(19) United States
(12) Patent Application Publication
(10) Pub. No.: US 2024/0202501 A1
(43) Pub. Date: Jun. 20, 2024

(54) SYSTEM AND METHOD FOR MATHEMATICAL MODELING OF HARDWARE QUANTIZATION PROCESS

(71) Applicant: Black Sesame Technologies Inc., San Jose, CA (US)

(72) Inventor: Peng Zan, Gaithersburg, MD (US)

(73) Assignee: Black Sesame Technologies Inc., San Jose, CA (US)

(21) Appl. No.: 18/081,515

(22) Filed: Dec. 14, 2022

(51) Int. Cl. G06N 3/0464; G06F 9/30; G06N 3/063

(52) U.S. Cl. CPC G06N 3/0464; G06F 9/3001; G06F 9/30134; G06N 3/063

(57) ABSTRACT

In one aspect, a system that can minimize quantization accuracy losses when implementing a neural network node on an edge device is disclosed. During operation, the system identifies a set of adjustable parameters in the edge device. The set of adjustable parameters include a set of registers of the edge device. The system then models the quantization of parameters and output of the neural network node on the edge device as an optimization problem by formulating at least an objective function, wherein the objective function is a function of the set of adjustable parameters. Next, the system solves the optimization problem by identifying a set of values for the set of adjustable parameters that satisfies the objective function. The system subsequently programs the edge device by configuring the set of adjustable parameters with the set of identified values. The programmed edge device implements the neural network node with improved precision.

### BACKGROUND

### Field

The disclosed embodiments generally relate to quantization of neural network parameters. More specifically, the disclosed embodiments relate to using an optimization technique to improve neural network quantization accuracy on edge devices.

### Related Art

Deep neural networks (DNNs) have been widely used in AI-enabled edge devices such as autonomous driving chips, home security systems, and autonomous robots, among others. However, due to the large model size of the DNNs and limited computational power associated with the edge computing devices, there is an increasing demand for techniques that can reduce the DNN model size and decrease power consumption without significant compromise on inference speed. Note that improvements on inference speed and power efficiency can also reduce cloud-infrastructure costs and would make it possible to run these computational tasks on heterogeneous devices such as smartphones, internet-of-things devices, and on various types of low-power hardware.

Some existing attempts to achieve the above combined objectives include building light-weight models using a bottom-up approach and reducing model size by using a combination of quantization, pruning and compression techniques. However, when deploying the above models to edge devices, such as application-specific integrated circuit (ASIC)-based devices, they oftentimes experience decreased model accuracies, as a result of hardware-specific algorithmic operations on these devices imposing constraints on the quantization process of the deployed models.

### SUMMARY

Embodiments of this disclosure provide a mathematical modeling and optimization system and process for neural network parameter quantization on edge (computing) devices, e.g., application-specific integrated circuit (ASIC)-based mobile devices that contain multiplier-accumulator (MAC) units or MAC arrays. Within an edge device, these MAC units or arrays are configured to perform both neural network parameter quantization (or simply “neural network quantization”) and neural network model execution, layer by layer, through multiplications, additions and bit-level manipulations. The disclosed systems and techniques mathematically model/formulate the arithmetic operations and parameter quantization processes of each neural network layer on the MAC units/arrays as an optimization problem and solve the optimization problem against a set of adjustable quantization parameters to minimize the neural network quantization accuracy losses and achieve highest possible quantization precisions for each of these arithmetic operations.

In various embodiments, the formulated optimization problem of neural network quantization and execution is composed of a set of optimizable variables, an objective function of the set of optimizable variables, and a set of constraints (which can include both equality and inequality constraints). Because the neural network model and neural network parameter quantization are implemented on the hardware, such as a set of MAC units, the disclosed systems and techniques further include mapping the optimizable variables of the objective function to a set of adjustable hardware parameters, such as a set of adjustable MAC registers. Hence, the disclosed systems and techniques further include solving the optimization problem by optimizing the adjustable hardware parameters to meet the objective function and the set of constraints.

In one aspect, a system that can minimize quantization accuracy losses when implementing a neural network node on a hardware device is disclosed. During operation, the system identifies a set of adjustable parameters in the hardware device. In some embodiments, the set of adjustable parameters includes a set of registers of the hardware device. The system then models the quantization of neural network parameters and intermediate output of the neural network node on the hardware device as an optimization problem by formulating at least an objective function, wherein the objective function is a function of the set of adjustable parameters. Next, the system solves the optimization problem by identifying a set of values for the set of adjustable parameters that satisfies the objective function. The system subsequently programs the hardware device by configuring the set of adjustable parameters with the set of identified values. The programmed hardware device is then used to implement the neural network node with improved precision at the output of the neural network node.

### DESCRIPTION OF THE FIGURES

FIG. 1 demonstrates an exemplary multiplication operation implemented on an MAC unit that incorporates the proposed bit-shifting and clipping operations in accordance with some embodiments described herein.

FIG. 2A shows a typical building block of a residual neural network (ResNet).

FIG. 2B shows an exemplary Conv-Add layer model which implements the building block illustrated in FIG. 2A with a four-dimensional (4D) tensor as the inputs in accordance with some embodiments.

FIG. 3 illustrates a generalized neural network quantization model derived from the Conv-Add layer model of FIG. 2B that includes multiplications, additions, and bit-shifts operations in accordance with some embodiments.

FIG. 4 presents a flowchart illustrating an exemplary process for mathematically modeling the quantization processes of a neural network node as an optimization problem and solving the optimization problem to minimize the quantization accuracy losses in accordance with some embodiments of the present invention.

FIG. 5 conceptually illustrates a computer system with which some embodiments of the subject technology can be implemented.

Table 1 show exemplary quantization accuracy comparisons before and after performing the proposed mathematical modeling and optimization procedures.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

Embodiments of this disclosure provide a system and method for mathematical modeling and optimization of the quantization of neural network parameters and output on edge computing devices, e.g., application-specific integrated circuit (ASIC)-based mobile devices that contain multiplier-accumulator (MAC) units or MAC arrays. Within an edge device, these MAC units or arrays are configured to perform both neural network parameter quantization (or simply “neural network quantization”) and neural network model execution, layer by layer, through multiplications, additions, and bit-level manipulations. The disclosed systems and techniques can be used to mathematically model and formulate the arithmetic operations and parameter quantization processes of each neural network layer on the MAC units or arrays as an optimization problem. Using the disclosed techniques, one can then solve the optimization problem against a set of adjustable quantization parameters to reduce accuracy losses in the neural network quantization process and improve the quantization precisions.

In various embodiments, the formulated optimization problem of neural network quantization and execution is composed of a set of optimizable variables, an objective function of the set of optimizable variables, and a set of constraints (which can include both equality and inequality constraints). Because the neural network model and neural network parameter quantization are implemented in the hardware, such as a set of MAC units, the disclosed systems and techniques further include mapping the optimizable variables of the objective function to a set of adjustable hardware parameters, such as a set of adjustable values stored in the MAC registers. Hence, the disclosed systems and techniques further include solving the optimization problem by optimizing the adjustable hardware parameters to meet the objective function and the set of constraints. Note that a neural network layer can be denoted as a neural network node when represented in a graph. The disclosed systems and techniques can be applied to different NN node types or graph structures, including but not limited to a Conv node, a Conv-ReLU node, a Conv-Add-ReLU node, and a Conv-ReLU-Add node.

Neural network (NN) quantization, which is a process of converting high-precision floating point numbers (e.g., 32-bit floating point numbers) into low bit depth integer representations (e.g., int8 numbers), can significantly reduce the NN model size before deployment to edge devices, thereby reducing memory and computational resource requirements, and power consumption. For example, when quantizing weights of a NN model from the 32-bit floating-point scheme to the 8-bit fixed-point scheme, the model size can be reduced by a factor of 4. Generally speaking, various NN quantization techniques can be classified into: (1) post-train quantization (PTQ) wherein quantization is performed on a model after model training; and (2) quantization-aware training (QAT), wherein quantization processes are embedded into a neural network and the model is trained in conjunction with the quantization process. In comparison, the PTQ approach is generally easier to implement, whereas the QAT approach tends to have higher model accuracy because of the retraining process.

A basic feature of a quantization scheme is that it permits efficient implementation of a wide range of arithmetic operations using only integer arithmetic operations on the quantized values. In other words, the quantization scheme is an affine mapping of integers q to real numbers (including floating point values) r based on the following linear transformation scheme:

$$r = s * ( q - z ) , \qquad ( 1 )$$

wherein s and z are constant value further described below. Note that Equation (also referred to as “Eqn.” below) 1 provides a quantization scheme, wherein q is the quantized value and the constants s and z are the quantization parameters. For per-tensor quantization, the quantization scheme uses a single set of quantization parameters for all values within each activations array and within each weights array. Meanwhile, separate arrays use separate quantization parameters.

For 8-bit quantization, q is quantized as an 8-bit integer (for B-bit quantization, q is quantized as a B-bit integer). Some arrays, such as bias vectors, can be quantized as 24-bit or 32-bit integers.

The constant s (also referred as the “scale” or the “quantization scale”) can be a positive real number. Generally speaking, scale s can be used to define a floating-point range that corresponds to a single binary bit in the quantized value representation. Scale s can also be viewed as a linear mapping constant that maps an integer value q to the corresponding floating-point value r. Scale s also dictates the resolution of the above linear mapping, whereas a smaller value of scale s corresponds to a higher resolution of the linear mapping. Note that scale s is typically represented in software as a floating-point quantity, similar to the real values r. The constant z (also referred as the “zero-point” or the “bias”) is of the same numeric type as the quantized value q, and can be regarded as the quantized value q corresponding to the real value 0. This designation allows the quantization scheme to provide that real value r=0 be represented by a quantized value. The motivation for this feature is that efficient implementation of neural network operators often requires zero-padding of arrays around boundaries.

In various embodiments, when PTQ scheme is used, the process of estimating s and z can include a calibration process. In contrast, when QAT scheme is used, the process of estimating s and z can be based on retraining a floating-point network. However, determining the quantization parameters s and z for each layer in a neural network is not the focus of this patent disclosure, which can be different for different network layers. Given a set of quantization parameters for each layer in a neural network, the quantized value q for any given input real value r can be derived from Eqn. 2 below:

$$\text{?} = clip ( ⌊ \frac{r}{s} ⌉ , N , P ) + z \qquad ( 2 )$$

$$\text{?} \text{indicates text missing or illegible when filed}$$

wherein the operator around the quantity r/s performs a rounding-to-the-nearest integer operation, and the “clip” operator takes the rounded integer after rounding of r/s and clips/fits the rounded value within the range specified by bounds N and P. For B-bit signed integers, N=−2^{B-1} and P=2^{B-1}−1 are the lower bound and the upper bound of the integer representation, respectively. For unsigned integers, the values for N and P are N=0 and P=28-1, respectively. For example, with int8 (signed) representation, N=−128, and P=127 for signed integers. Note that to reduce the incidences of actually clipping a rounded value, a process referred to “calibration” can be first performed on a calibration dataset before the quantization process, which is configured to determine a range (i.e., both the minimum value and the maximum value) for the input floating-points numbers which is then used to determine the proper scale s in Eqn. 2. For example, if the calibrated floating-point number range is [−1, 1], the scale s=2⁻⁷, as calculated by dividing the floating range with the integer range, i.e., 2/2⁸. As a result, the actual input values during quantization process can largely fall within the predefined bounds of N and P. In various embodiments, the calibration dataset is collected from the outputs (i.e., activations) of all the layers (except the final layer) of a given neural network to achieve the maximum coverage of the possible activation data value range. However, clipping can still occur during actual quantization operation because the calibration dataset may not always cover the actual data range during the actual quantization operation. Therefore, when performing algorithmic operations such as additions and multiplications on the quantized integers, the system can perform the same operations on the dequantized values in the floating-point domain, as shown in Eqn. 3,

$$\hat{r} = s * ( \hat{q} - z ) . \qquad ( 3 )$$

### Hardware Operations and Effects on Quantization Accuracy

In convolutional neural networks (CNN), computational structures such as Conv, Conv-ReLU, Conv-Add-ReLU, Conv-ReLU-Add, etc., can be implemented in MAC units, because their arithmetic operations include multiplications, additions and comparisons. However, when multiplying two fixed-point values, both quantization scale and range can change during the operation. By performing both bit-shifting and clipping operations on the output values of the multiplication operation, it is possible to ensure that an integer value from the MAC output to be within the original B-bit range.

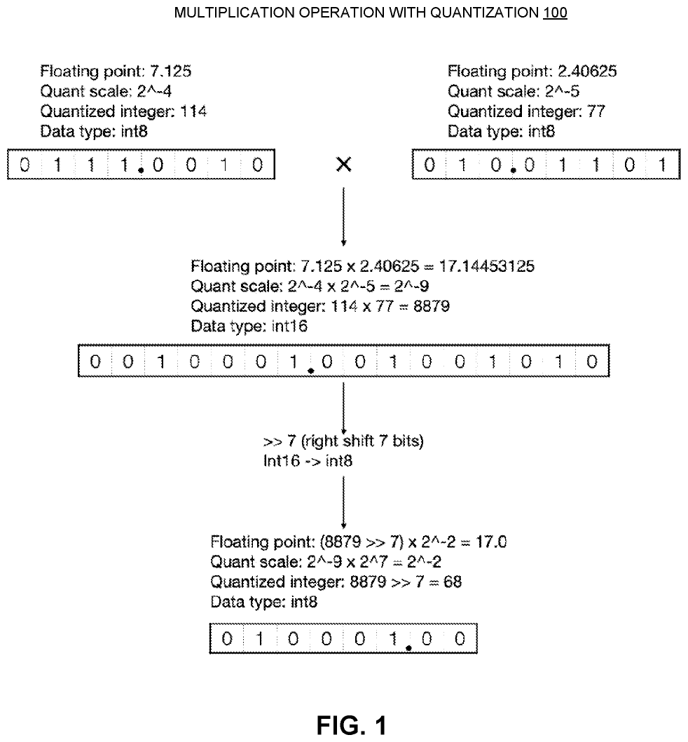

FIG. 1 demonstrates an exemplary multiplication operation with quantization implemented on an MAC unit that incorporates the proposed bit-shifting and clipping operations, in accordance with some embodiments described herein. As can be seen in FIG. 1, a floating-point multiplication takes place between two exemplary input floating-point numbers 7.125 and 2.40625, which are associated with two different quantization scales of 2⁻⁴ and 2⁻⁵, respectively. An int8 unsigned representation is used for the quantization process. In the scope of a neural network, 7.125 can be considered an input value of a given layer (or node) whereas 2.40625 can be the associated weight value. In some embodiments, the weight tensors and the input tensors can be independently calibrated for the neural network to determine the proper quantization scales (also referred to as “quant scale” hereinafter) from the weights and the inputs, respectively. This is the reason that two exemplary floating-point numbers 7.125 and 2.40625 can have different quant scales of 2⁻⁴ and 2⁻⁵, respectively. FIG. 1 shows the binary representations of the two floating-point numbers, wherein the black dot in each binary representation indicates the corresponding mantissa point.

In this example, the first quant scale 2⁻⁴ is obtained by computing 2³/2⁷, whereas the second quant scale 2⁻⁵ is obtained by computing 2²/2⁷. Note that the smaller floating-point number is associated with a larger quant scale whereas the larger floating-point number is associated with a smaller quant scale. This flexible arrangement allows for fully utilizing the bit range for each of the two values to achieve an optimal accuracy. As will be further discussed below, keeping the flexible and variable quant scales through algorithmic operations provides one of the tools for quantization optimization.

Referring to FIG. 1, note that the intermediate result for the multiplication of the two floating-point numbers is a floating-point number 17.14453125 with an expanded fixed point representation of int16 and a corresponding quant scale of 2⁻⁹, which is the product of the two original quant scales of 2⁻⁴ and 2⁻⁵. However, to maintain the low-bit depth of int8 at the output, a 7-bit right shift is applied at the output (which is equivalent to removing the 7 least significant bits (LSBs)). This produces the quantized output value of 68 and a new quant scale of 2⁻² (product of quant scale of 2⁻⁹ and bit shift 2⁷). By applying the linear mapping of Eqn. 1, the final output in real value is 17.0. As can be seen, the bit-shifting and clipping operations through the multiplication operation 100 introduce precision loss from the full precision multiplication result 17.14453125 to the final result of 17.0. This precision loss can propagate through the entire neural network and reduce the accuracy of the final layer output. To mitigate the above-described precision losses as a result of bit-shifting in the quantization processes, to the system and method disclosed herein can formulate each neural network node quantized and implemented on hardware (e.g., on a set of MAC units) as an optimization problem including at least one objective function and a number of constraints. To facilitate constructing the optimization problem, the system can mathematically model the hardware algorithmic operations at each computation node of the quantized neural network. In some embodiments, the formulated optimization problem can be solved through derivations and/or search techniques to produce an optimized solution that meets the objective functions under the constraints. In some embodiments, the optimized solution specifies a set of determined bit-shifts for the algorithmic operations that can minimize the quantization accuracy losses.

The present inventive system and method include a general layer-wise procedure to model hardware algorithmic operations in terms of quantization parameters, in particular the quant scale parameter s. As mentioned above, some of the applicable hardware algorithmic operations include multiplications, additions, bit-shifting, and clipping. The mathematical representations for these hardware algorithmic operations are described below, wherein operations over value representations are compared between the software representation (in floating point values r) and the hardware representation (in quantized values q). Once mathematical models are provided to various algorithmic operations/modules, the present disclosure further describes how to incorporate these individual modules into a single optimization model for the neural network quantization process at a given computation node.

### Power-of-Two Quantization Scales

Because fixed-point binary representation is generally implemented in the hardware, the quant scale s should be designated as power-of-two, i.e., s∈{2ⁱ|i∈Z}, namely, 1, 0.5, 0.25, 0.125, etc. For the symmetric quantization scheme with signed integers, zero-point z=0, and we have,

$$s = \frac{{υ}_{max}}{{q}_{max}} \qquad ( 4 )$$

$${υ}_{max} = \text{?}$$

$${q}_{max} = max ( \vert N \vert , \vert P \vert )$$

$$\text{?} \text{indicates text missing or illegible when filed}$$

wherein rₘᵢₙ and rₘₐₓ are the calibrated (i.e., using a calibration dataset) tensor values representing the lower and upper boundaries of a value range, respectively. As such, vₘₐₓ is in power of two, because N=−2^{B-1} and P=2^{B-1}−1, where B is the number of bits for the fixed-point representation, qₘₐₓ=2^{B-1}. For example, if int8 fixed point representation is implemented on the hardware, then B=8 and qₘₐₓ=128. Therefore, the calculated quantization scale s from Eqn. 4 is also in power of two. As an example, when Eqn. 4 is applied to the exemplary multiplication operation 100 in FIG. 1, the system can obtain the quantization scales of 2⁻⁴ and 2⁻⁵ for the two input floating-point numbers 7.125 and 2.40625, respectively. One way to interpret the expression of the quantization scale s in Eqn. 4 is that the quant scale s corresponds to the amount of floating-point numbers that the least significant bit (LSB) represents. As a result, the fractional length of the fixed-point number can be expressed as:

$$l = - {log}_{2} s . \qquad ( 5 )$$

### Bit Shifting

When a right-shift by k bits is performed on a quantized value q, the updated quantized value q′ can be expressed by Eqn. 6:

$$\begin{matrix}{q}^{′} = q >> k \\ = ⌊ q * {2}^{- k} ⌋ .\end{matrix} \qquad ( 6 )$$

For the symmetric quantization scheme, z=0, and r=s*q=s*q′*2^{k}. Therefore, after right-shifting by k bits, the quant scale becomes:

$${s}^{′} = s * {2}^{k} . \qquad ( 7 )$$

In other words, right-shift by k bits on hardware results in quantization scale to be upscaled by 2^{k}. Based on Eqn. 13 below, for a power-of-two quantization scale s=2^{-l}, the mantissa in a floating-point value is represented by the last l bits of q. The exemplary multiplication operation 100 in FIG. 1 demonstrates the right-shift operation and the effects on the quantized value and quantization scale in accordance with Eqn. 6 and Eqn. 7.

### Clipping

When clipping is performed on a quantized value q to q′ with the lower and upper bounds N and P, respectively, using the following expression:

$${q}^{′} = clip ( q , N , P ) , \qquad ( 8 )$$

Eqn. 8 can be translated into the following equation,

$${q}^{′} = \{ \begin{matrix}N \text{?} & if q \leq N \\ P , & if q \geq P \\ q \text{?} & otherwise\end{matrix} \qquad ( 9 )$$

$$\text{?} \text{indicates text missing or illegible when filed}$$

With the power-of-two scale, the value for P is P=−N=2^{B-1} for B-bit signed integers. When clipping is performed on an array with vₘₐₓ as the upper bound of the real-value range, with the expression given by Eqn. 4, the quantization scale s needs to satisfy the constraint specified in Eqn. 10 below in order to represent the entire real-value range without precision loss as a result of the clipping operation:

$$\frac{{v}_{max}}{s} \leq P . \qquad ( 10 )$$

### Addition and Concatenation

In order for algebraic operations on hardware to perform correctly, mantissa point alignment is required for operations such as addition and concatenation. The mathematical explanation for addition is described in Eqn. 11 below, and the mantissa point alignment requirement further requires the quantization scales s₁ and s₂ associated with two quantized values q₁ and q₂ of the addition to equal each other to allow q₁ and q₂ to be added directly. After the addition operation, the new quantized value becomes q′=q₁+q₂, and the corresponding quantization scale is s′=s₁=s₂. The above expressions and conditions associated with the addition operation are summarized below:

$${r}^{′} = {r}_{1} + {r}_{2} = {s}_{1} * {q}_{1} + {s}_{2} * {q}_{2} = {s}_{1} * ( {q}_{1} + {q}_{2} ) = {s}^{′} * {q}^{′} \qquad ( 11 )$$

$${s}_{1} = {s}_{2} .$$

Concatenation is an operation that combines two tensors into one, which is then processed across the same pipeline. Therefore, for per-layer quantization, two tensors need to have the same number of mantissa bits for the combined tensor to participate in the next processes.

### Multiplication

In CNN, a multiplication operation can take place between input values and corresponding weights. Without losing generality, the multiplication between two real-valued numbers r₁ and r₂ can be modeled in Eqn. 12 below:

$${r}^{′} = {r}_{1} * {r}_{2} = ( {s}_{1} * {q}_{1} ) * ( {s}_{2} * {q}_{2} ) = ( {s}_{1} * {s}_{1} ) * ( {q}_{2} * {q}_{2} ) = {s}^{′} * {q}^{′} , \qquad ( 12 )$$

wherein r′=r₁*r₂ is the resulting product in floating-point number, s′=s₁*s₂ is the quantization scale of the multiplication output, and q′=q₁*q₂ is the quantized value of the resulting product.

### Mathematical Modeling of Quantization Process

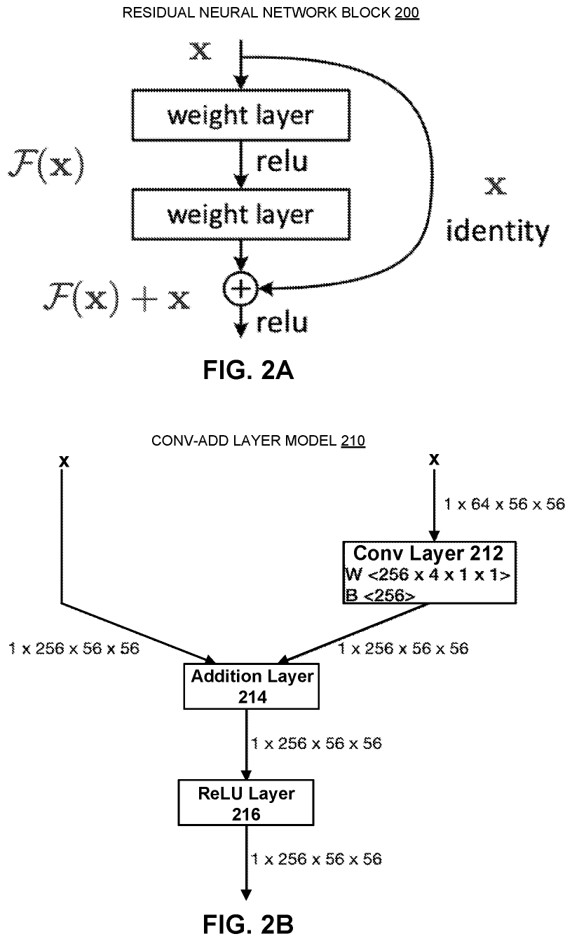

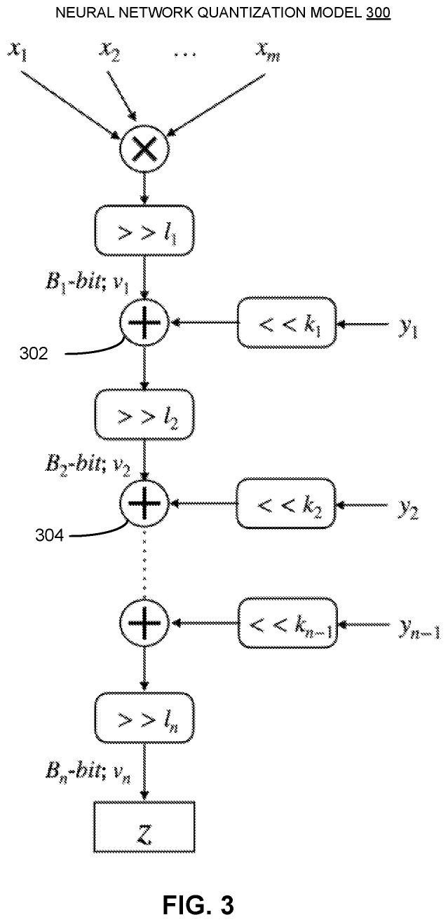

After formulating mathematical models for individual quantization processes corresponding to various hardware algorithmic operations, a mathematical model can be derived for any neural network structure/node which is built upon the various hardware algorithmic operations. As an example, we provide a mathematical abstraction of a graph structure generalized from a convolutional layer containing an “add” node, which is widely used in the residual neural network (ResNet) framework: a powerful NN architecture for classification and object detection tasks. FIG. 2A shows a typically building block 200 of a residual neural network. As can be seen in FIG. 2A, the building block 200 maps an input x to the output formulation F(x)+x by using a feedforward scheme with “shortcut connections.” More detailed operation of the building block 200 of a ResNet can be found in Kaiming He et al. “Deep Residual Learning for Image Recognition,” 2016 IEEE Conference on Computer Vision and Pattern Recognition (CVPR), pp. 770-778.

FIG. 2B shows an exemplary Conv-Add layer model 210 which implements the building block 200 in FIG. 2A with a four-dimensional (4D) tensor as the inputs in accordance with some embodiments. Specifically, the input to Conv-Add layer model 210 is a 4D tensor <x> having the size of <1×64×56×56>. The weight layer in building block 200 is implemented in Conv-Add layer model 210 as a Conv layer 212 which contains both 4D weight tensor <W> of size <256×4×1×1> and a one-dimension (1D) bias <B> of size <256>. Conv layer 212 performs convolution operations on input tensor <x>, which include both multiplication operations between input tensor <x> and weight tensor <W>, and the subsequently addition operations between the results of the above multiplication operations and bias <B>. Note that when Conv layer 212 is implemented on hardware, such as one or more MAC units, quantization processes are performed before the multiplication operations, which are then followed by bit-shifting operations. The additional computation components within building block 200 are implemented in Conv-Add layer model 210 as addition layer 214 and ReLU layer 216, which perform additional algorithmic operations, such as multiplications, additions, bit-shifts and clipping.

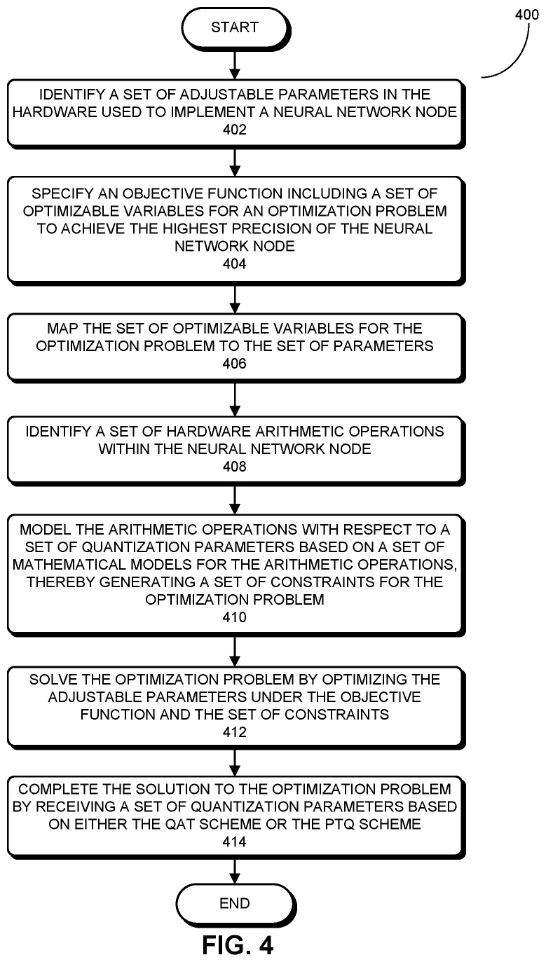

To facilitate constructing an optimization problem to minimize quantization accuracy losses associated with the quantization processes when Conv-Add layer model 210 is implemented on hardware, a mathematical abstraction of Conv-Add layer model 210 incorporating the above-described mathematical models of various hardware algorithmic operations is needed. FIG. 3 illustrates a generalized neural network quantization model 300 derived from the Conv-Add layer model 210 of FIG. 2B that includes multiplications, additions, and bit-shifts operations in accordance with some embodiments. Note that Conv-Add layer model 210 can be considered as one specific implementation of neural network model 300.

As shown in FIG. 3, a mathematically generalized modeling of hardware implementation 300 of a Conv-Add layer in a neural network receives two sets of inputs: (1) x₁, x₂, . . . , xₘ, and (2) y₁, y₂, . . . , yₙ. Note that the set of inputs x₁, x₂, . . . , xₘ are involved in a set of multiplication operations, while the set of inputs y₁, y₂, . . . , yₙ are involved in a set of (n−1) addition operations. After quantization of the input values, we denote sₓ₁, sₓ₂, . . . , sₓₘ as the quantization scales for x₁, x₂, . . . , xₘ, and s_{y1}, s_{y2}, . . . , s_{yn} as the quantization scales for y₁, y₂, . . . , yₙ. We further denote s_{Aj} as the quant scale for j^{th} addition operation, wherein j=1, . . . , n−1, and s_{z} as the quant scale for final output z. Note that these quantization parameters deterministic and are provided by either the QAT scheme or the PTQ scheme. Moreover we use Bⱼ to represent signed integer bits for the sequence of addition branches (e.g., int8, int16, etc.), wherein j=1, . . . , n. We further use vⱼ to denote the maximum real-value in power-of-two for the sequence of addition branches, wherein j=1, . . . , n.

As can be seen in FIG. 3, there are also a set of right bit-shifting operations in the main computation path of neural network model 300, which are denoted as lⱼ, j=1, . . . , n. Moreover, there is a set of left bit-shifting operations associated with the set of addition branches, which are denoted as kⱼ, j=1, . . . , n−1. In the formulated optimization problem for neural network model 300, the set of right bit-shift values {l₁, . . . , lₙ} and the set of left bit-shift values {k₁, . . . , kₙ₋₁} are the optimization variables, given the quantization scales {sₓ₁, sₓ₂, . . . , sₓₘ} of inputs xᵢ, and the quantization scales {s_{y1}, s_{y2}, . . . , s_{yn}} of inputs yⱼ, and the quant scale s_{z} for output z. Because a larger right bit-shift value causes a higher loss in quantization accuracy, one embodiment of the objective function of the optimization problem is formulated to minimize the weighted sum of the right bit-shift values lⱼ's. This objective function is expressively shown in Eqn. 13a.

$$\text{?} n * {l}_{1} + ( n - 1 ) * {l}_{2} + … + {l}_{n} \qquad ( 13 a )$$

$$s . t . {\prod }_{i = 1}^{m} {s}_{{x}_{i}} * \text{?} = {s}_{z} \qquad ( 13 b )$$

$${\prod }_{i = 1}^{m} {s}_{{x}_{i}} * \text{?} = {s}_{{y}_{j}} * {2}^{- {k}_{j}} , j ∈ \{ 1 , … , n - 1 \} \qquad ( 13 c )$$

$${s}_{{A}_{j}} = {s}_{{y}_{j}} * {2}^{- {k}_{j}} , j ∈ \{ {a}_{1} , … , {a}_{t} \} \qquad ( 13 d )$$

$${M}_{j} \leq {l}_{j} \leq {N}_{j} , {l}_{j} ∈ ℤ , j ∈ \{ 1 , … , n - 1 \} \qquad ( 13 e )$$

$${P}_{j} \leq {k}_{j} \leq {Q}_{j} , {k}_{j} ∈ ℤ , j ∈ \{ 1 , … , n - 1 \} \qquad ( 13 f )$$

$$\frac{{υ}_{j}}{{s}_{{y}_{j}} * {2}^{- {k}_{j}}} \leq {2}^{{B}_{j} - 1} , j ∈ \{ 1 , … , n - 1 \} \qquad ( 13 g )$$

$$\text{?} \text{indicates text missing or illegible when filed}$$

As can be seen in Eqn. 13a, the right bit-shift values lⱼ are weighted based on the amount of impact of each lⱼ on the overall accuracy of quantization. Specifically, a right bit-shift operation performed closer to the input stage (i.e., having a smaller j) will have a higher impact on the quantization accuracy than another right bit-shift operation performed more downstream in neural network model 300, i.e., further away from the input stage. Therefore, l₁, which has the largest impact on the overall quantization, is assigned with the highest weight n. Similarly, l₁, which has the second largest impact on the overall quantization, is assigned with the second highest weight n−1, and so on. The objective of Eqn. 13a is to minimize the total weighted sum of the right bit-shifts of the entire quantization processes within neural network model 300, thereby obtaining the highest achievable accuracy of quantization. Note that regardless the weighting scheme used in the objective function, the main goal of the corresponding optimization problem is to use as fewer right-shift bits as possible while searching for feasible solutions of the optimization problem.

In addition to the objective function, the formulated optimization problem to obtain the highest achievable quantization accuracy also includes a set of formulated constraints. In various embodiments, these constraints can be classified into two categories: (1) hardware constraints related to the hardware resource limitations of the hardware implementing the neural network node; and (2) equality and inequality constraints dictated by the mathematical representations used to model various hardware quantization processes. Eqns. 13b-c and Eqns. 13e-g provide the formulations of these two categories of constraints which complement the objective function Eqn. 13a to fully described the optimization problem to be solved.

Eqn. 13b describes the relationship between quant scales {sₓ₁, sₓ₂, . . . , sₓₘ} of inputs x; and the quant scale s_{z} of the final output z. In other words, Eqn. 13b specifies an equality constraint that must be satisfied by a valid optimization solution of the optimization problem. More specifically, the constraint of Eqn. 13b requires that the quant scale s_{z} of the final output z be equal to the sum of quant scales {sₓ₁, sₓ₂, . . . , sₓₘ} of inputs {x₁, x₂, . . . , xₘ} while factoring in the total amount of the right bit-shifts {l₁, . . . , lₙ}.

Eqn. 13c specifies a group of n−1 equality constraints originated from the above-described quant-scale equality requirement for two inputs of a given addition operation. To simply put, Eqn. 13c dictates that the two quant scales associated with the two inputs at each of the addition operator should be equal to each other. Because there are a total of n−1 such addition operators in neural network model 300, there are n−1 corresponding equality constraints in Eqn. 13c. For example, when j=1, Eqn. 13c is reduced to

$${\prod }_{i - 1}^{m} {s}_{xi} * {2}^{{l}_{1}} = {s}_{y 1} * {2}^{- {k}_{1}} ,$$

which is exactly the quant-scale equality requirement for the first addition operation 302. As another example, when j=2, Eqn. 13c is reduced to

$${\prod }_{i - 1}^{m} {s}_{xi} * {2}^{{l}_{1} + {l}_{2}} = {s}_{y 2} * {2}^{- {k}_{2}} ,$$

which is exactly the quant-scale equality requirement for the second addition operation 304. Eqn. 13d is the constraint for jth addition when quantization scale for jth addition output is given.

Eqn. 13e and Eqn. 13f specify two hardware constraints which are introduced by the hardware (i.e., registers) that are used to implement the bit-shift operations of {l₁, . . . , lₙ} and {k₁, . . . , kₙ₋₁}. Specifically, Eqn. 13e specifies an inequality constraint that dictates an allowable of bit shifts for each of the bit-shift operations {l₁, . . . , lₙ}. Similar, Eqn. 13f specifies an inequality constraint that dictates an allowable range of bit shifts for each of the bit-shift operations {k₁, . . . , kₙ₋₁}. A person skilled in the art can appreciate that the upper bounds of these hardware constraints are related to the maximum number of registers in the hardware that are available for performing the bit shift operations.

Finally, Eqn. 13g specifies an inequality constraint which is applied by each calibrated range vⱼ on the corresponding left bit-shift kⱼ at each addition operation. The rationale behind this constraint has been provided above in conjunction with the constraint specified in Eqn. 10, which is to avoid clipping the calibrated range vⱼ and thereby avoiding quantization precision losses. As an example, v₁ at the first addition operation 302 represents the calibrated maximum floating-point value of all the output values after the first right bit-shift operation l₁. B₁ represents the number of bits in the fixed point representation. s_{y1}*2^{-k}^{₁} is the quant scale of floating-point number v₁. To map the floating-point value v to the quantized value, we divide v₁ by the quanta scale s_{y1}*2^{-k}^{₁}, and the corresponding inequality constraint Eqn. 13g ensures that the quantized integer of v₁ is not greater than the upper bound of the integer range 2^{B}^{₁}⁻¹.

Note that the objective function of Eqn. 13a and the set of constraints described in Eqn. 13b to Eqn. 13g represent the formulated optimization problem that mathematically describes the quantization processes of neural network model 300. In some embodiments, an optimized solution to the optimization problem includes a set of determined right bit-shift values {l₁, . . . , lₙ} that meets the objective function and the set of constraints, and therefore minimizing the quantization accuracy losses when the optimized solution is applied to neural network model 300.

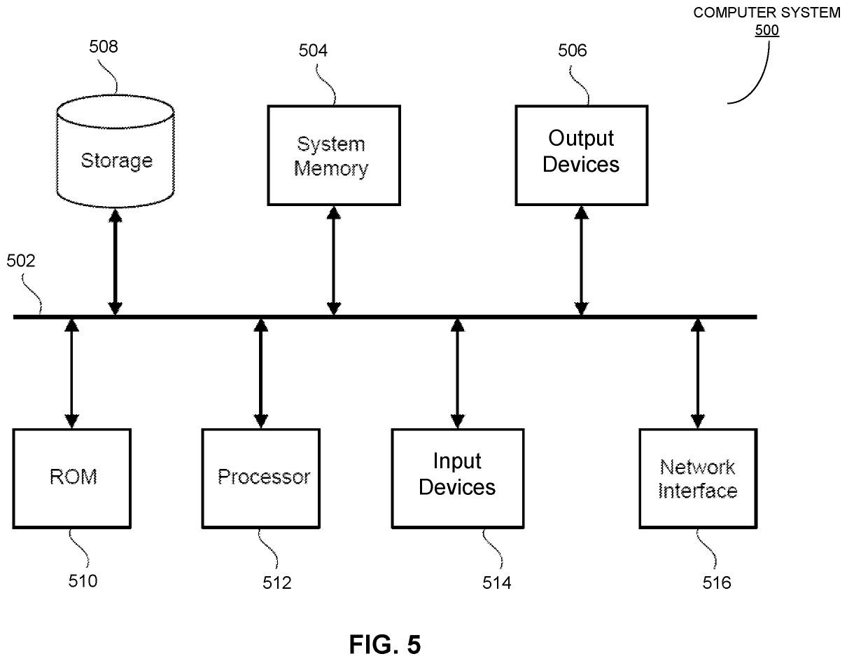

FIG. 4 presents a flowchart illustrating an exemplary process 400 for mathematically modeling the quantization processes of a neural network node as an optimization problem and solving the optimization problem to minimize the quantization accuracy losses in accordance with some embodiments described herein. In one or more embodiments, one or more of the steps in FIG. 4 may be repeated and/or performed in a different order. Accordingly, the specific arrangement of steps shown in FIG. 4 should not be construed as limiting the scope of the technique.

In various embodiments, the formulated optimization problem is composed of a set of optimizable variables, an objective function of the set of optimizable variables, and a set of constraints (which can include both equality and inequality constraints). Because the neural network node and the neural network parameter quantization are implemented on computer hardware, such as a group of MAC units, the proposed process 400 includes the steps of constructing various components of the optimization problem based on the hardware operations (e.g., MAC register operations). In various embodiments, the modeled neural network node is one of the CNN-based nodes, such as one of: a Conv node, Conv-ReLU node, a Conv-Add-ReLU node, and a Conv-ReLU-Add node.

During operation, process 400 may begin by identifying a set of adjustable parameters in the hardware used to implement the neural network node (step 402). For example, the set of adjustable parameters in a MAC unit can include a set of registers. Process 400 further specifies an objective function for the optimization problem aimed at achieving the highest possible precision at the output of the neural network node, wherein the objective function includes a set of optimizable variables (step 404). For example, the objective function can be configured to achieve the highest computational precision by minimizing the quantization accuracy losses through the chain of operations of the modeled neural network node. In some embodiments, to minimize the quantization accuracy losses through the chain of operations includes setting the set of optimizable variables as a set of bit-shift values corresponding to a set of right-shift operations in the chain of operations. For example, in the exemplary neural network model 300, the set of optimizable variables of the objective function includes the set of right bit-shift variables {l₁, . . . , lₙ}. Next, process 400 maps the set of optimizable variables of the objective function for the optimization problem to the set of adjustable parameters of the hardware (step 406). For example, in the exemplary neural network model 300, the set of bit-shift variables {l₁, . . . , lₙ} of the objective function is implemented with a set of registers of the MAC unit. As a result, the objective function can be formulated to minimize a weighted sum of the set of right bit-shift variables.

Next, process 400 identifies a set of hardware arithmetic operations within the neural network node (step 408). As described above, the set of arithmetic operations can include, but are not limited to multiplication, addition, bit-shift (both left-shift and right shift), clipping, rounding, and other arithmetic operations. For example, the exemplary neural network model 300 includes at least multiplications, additions, right bit-shifts and left bit-shifts. Process 400 then models these identified hardware arithmetic operations with respect to a set of quantization parameters based on the set of established mathematical models for these arithmetic operations, thereby generating a set of constraints for the optimization problem (step 410).

Specifically, the set of quantization parameters for each modeled hardware arithmetic operation includes a set of quant scales, zero points, and the calibrated vₘₐₓ values/ranges defined in Eqn. 10. Moreover, the set of established mathematical models for the set of common hardware arithmetic operations is formulated based on the set of Eqns. 4-12 above.

The set of generated constraints can include quant-scale equality constraints between the quant scales of a set of input values of the neural network node and the quant scale of the final output of the neural network node, wherein the neural network node transforms the set of input values through a set of multiplications, additions, and bit-shifts. An example of these quant-scale equality constraints was provided above in conjunction with Eqn. 13b. The set of generated constraints can also include quant-scale equality constraints for the two inputs of each identified addition operation in the neural network node. Examples of these quant-scale equality constraints for neural network model 300 were provided above in conjunction with Eqn. 13c. The set of generated constraints can also include quant-scale equality constraints for the two inputs of each identified addition operation in the neural network node. Examples of this quant-scale equality constraint for neural network model 300 were provided above in conjunction with Eqn. 13c.

The set of generated constraints can additionally include hardware constraints, e.g., in the form of an inequality introduced by the hardware (i.e., MAC registers) that are used to implement the bit-shift operations in the neural network node. Examples of these hardware constraints for neural network model 300 were provided above in conjunction with inequality constraints Eqn. 13e and Eqn. 13f. Moreover, the set of generated constraints can also include inequality constraints on the calibrated vₘₐₓ value/range for input values of an identified arithmetic operation in order to avoid quantization precision losses due to clipping the calibrated vₘₐₓ. Examples of these inequality constraints for neural network model 300 were provided above in conjunction with Eqn. 13g.

Next, process 400 solves the optimization problem by optimizing the adjustable variables/parameters under the objective function and the set of constraints (step 412). In some embodiments, process 400 solves the optimization problem by using an optimization technique, such as a linear optimization technique, or a brute-force search technique. Note that the solution to the optimization problem includes a set of optimized values for the set of adjustable variables/parameters that minimizes quantization accuracy losses. For example, the solution to the optimization problem for the exemplary neural network model 300 includes a set determined right bit-shifts {l₁, . . . , lₙ} that minimizes the weighted sum of the set of right bit-shifts.

After obtaining the optimized set of adjustable parameters for the optimization problem, process 400 can then receive a set of quantization parameters, including the quant scales, the zero points, and the calibrated vₘₐₓ values/ranges for the identified hardware arithmetic operations in the neural network node based on either the QAT scheme or the PTQ scheme (step 414). Note that the received set of quantization parameters when the QAT scheme is used to implement the neural network node is generally different from the received set of quantization parameters when the PTQ scheme is used to implement the neural network node. Note that the complete solution to the optimization problem of the quantization processes in the neural network node includes the optimized set of adjustable parameters that satisfies the objective function and the set of constraints, and the set of received quantization parameters based on either the QAT scheme or the PTQ scheme.

To validate the proposed optimization technique has effectively improved the neural network quantization accuracy, the optimization technique is applied to quantize a floating-point ResNet50 model (described in Kaiming He et al. “Deep Residual Learning for Image Recognition,” 2016 IEEE Conference on Computer Vision and Pattern Recognition (CVPR), pp. 770-778) under the PTQ scheme. Activations are calibrated using a calibration dataset extracted from the ImageNet dataset (Jia Deng et al. “Imagenet: A large-scale hierarchical image database,” 2009 IEEE conference on computer vision and pattern recognition, pp. 248-255). Quantization parameters for each tensor, both weights and activations, are calculated based on calibrated floating-point ranges and the int8 fixed-point representations. Next, a two-step shifts (by setting n=2 in the set of Eqns. 13) are applied for each Conv layer, including Conv-Add, Conv-Add-ReLU, etc. By applying the above-described mathematical modeling of the quantization processes on ResNet50 and solving the optimization problem formulated based on the set of Eqns. 13, it is found that the quantization accuracy associated with the optimized solution to the optimization problem has significant improvement over the non-optimized solution.

Table 1 shows exemplary quantization accuracy metrics before and after performing the proposed mathematical modeling and optimization procedures. As can be seen in Table 1, for ResNet50 with different sizes of image input, e.g., 224p, 720p and 1080p, the Signal-to-Quantization-Noise Ratio (SQNR) metric for the output layer of the ResNet50 is computed for each of the image sizes, and for each image size, also computed without (i.e., before) and with (i.e., after) performing the described mathematical modeling and optimization process. The computed SQNR values with and without the optimization are listed in Table 1 side-by-side. As clearly shown in Table 1, for each of the input image sizes, the post modeling and optimization result shows significant accuracy gain over the results before modeling and optimization. It should be noted that the exemplary results of Table 1 are generated based on tensor-wise quantization with MinMax calibration and int8 fixed-point quantization for both the activations and weights.

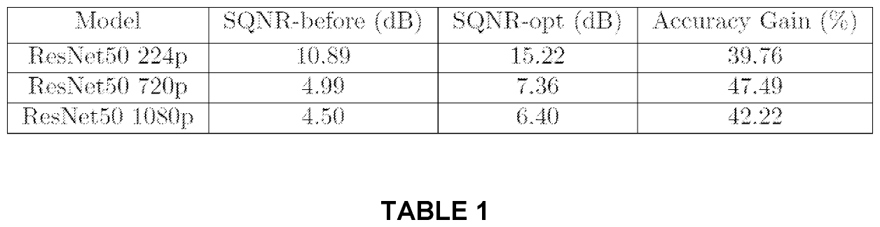

FIG. 5 conceptually illustrates a computer system with which some embodiments of the subject technology can be implemented, in accordance with embodiments of the present disclosure. A computer system 500 can be a client, server, smartphone, laptop, or a tablet computer with one or more processors embedded therein or coupled thereto, or any other sort of computing device. Such a computer system includes various types of computer-readable media and interfaces for various other types of computer-readable media. Computer system 500 can include a bus 502, processing unit(s) 512, a system memory 504, a read-only memory (ROM) 510, a permanent storage device 508, an input device interface 514, an output device interface 506, and a network interface 516.

Bus 502 collectively represents all system, peripheral, and chipset buses that communicatively connect the numerous internal devices of computer system 500. For instance, bus 502 communicatively connects processing unit(s) 512 with ROM 510, system memory 504, and permanent storage device 508.

From these various memory units, processing unit(s) 512 retrieves instructions to execute and data to process in order to execute various processes described in this patent disclosure, including the processes for mathematically modeling the quantization of a neural network node as an optimization problem and solving the optimization problem described in conjunction with FIGS. 1-4. The processing unit(s) 512 can include any type of processor, including but not limited to, a microprocessor, a graphic processing unit (GPU), a tensor processing unit (TPU), an intelligent processor unit (IPU), a digital signal processor (DSP), a field-programmable gate array (FPGA), and an application-specific integrated circuit (ASIC). Processing unit(s) 512 can be a single processor or a multi-core processor in different implementations.

ROM 510 stores static data and instructions that are needed by processing unit(s) 512 and other modules of the computer system. Permanent storage device 508, on the other hand, is a read-and-write memory device. This device is a non-volatile memory unit that stores instructions and data even when computer system 500 is off. Some implementations of the subject disclosure use a mass-storage device (such as a magnetic or solid state disk) as permanent storage device 508.

System memory 504 can be a read-and-write memory device. However, unlike storage device 508, system memory 504 can be a volatile read-and-write memory, such as a random access memory. System memory 504 stores some of the instructions and data that the processor needs at runtime. In some implementations, various processes described in this patent disclosure, including the processes for mathematically modeling the quantization of a neural network node as an optimization problem and solving the optimization problem described in conjunction with FIGS. 1-4, are stored in system memory 504, permanent storage device 508, and/or ROM 510. From these various memory units, processing unit(s) 512 retrieves instructions to execute and data to process in order to execute the processes of some implementations.

Bus 502 also connects to input and output device interfaces 514 and 506. Input device interface 514 enables the user to communicate information to and select commands for the computer system. Input devices used with input device interface 514 include, for example, alphanumeric keyboards and pointing devices (also called “cursor control devices”). Output device interface 506 enables, for example, the display of images generated by computer system 500.

Finally, as shown in FIG. 5, bus 502 also couples computer system 500 to a network (not shown) through a network interface 516. In this manner, the computer can be a part of a network of computers, an intranet, or the Internet.

The various illustrative logical blocks, modules, circuits, and algorithm steps described in connection with the embodiments disclosed in this patent disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

This patent disclosure presents various techniques to model algorithmic operations for neural network quantization process on computing hardware such as a group of MAC units and to formulate an optimization problem given a MAC unit processing path. For performance evaluation, the proposed modeling and optimization procedure was applied to a post-train quantization (PTQ)-based benchmark ResNet50 model. The testing results demonstrated significant accuracy improvement (i.e., >40% accuracy improvement) using the SQNR metric over the results from the same ResNet50 model when no optimization was used.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices, solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A computer-implemented method for minimizing quantization accuracy losses when implementing a neural network node on a hardware device, the method comprising:
identifying a set of adjustable parameters to be stored in the hardware device;
modeling the quantization of neural network parameters and output of the neural network node on the hardware device as an optimization problem by formulating at least an objective 5 function, wherein the objective function is a function of the set of adjustable parameters;
solving the optimization problem by identifying a set of values for the set of adjustable parameters that satisfies the objective function; and
programming the hardware device by configuring the set of adjustable parameters with the set of identified values, thereby allowing the programmed hardware device to implement the neural network node with improved precision at an output of the neural network node.

2. The computer-implemented method of claim 1, wherein the objective function is to minimize quantization accuracy losses in terms of a set of optimizable variables associated with the quantization of the set of neural network parameters; and
wherein formulating the objective function comprises mapping the set of optimizable variables of the objective function to the set of adjustable parameters of the hardware device.

3. The computer-implemented method of claim 2,
wherein the set of optimizable variables comprises a set of bit-shift variables associated with the quantization of the set of neural network parameters; and
wherein the set of adjustable parameters comprises a set of registers of the hardware device.

4. The computer-implemented method of claim 3, wherein the set of bit-shift variables comprises a set of right bit-shift variables, and wherein formulating the objective function to minimize quantization accuracy losses in terms of the set of optimizable variables comprises minimizing a weighted sum of the set of right bit-shift variables.

5. The computer-implemented method of claim 1,
wherein the optimization problem additionally comprises a set of constraints associated with the set of adjustable parameters; and
wherein solving the optimization problem comprises identifying the set of values for the set of adjustable parameters that satisfy the set of constraints.

6. The computer-implemented method of claim 5, wherein formulating the optimization problem further comprises generating the set of constraints by:
identifying a set of arithmetic operations within the neural network node; and
for each identified arithmetic operation, generating one or more constraints by mathematically modeling the arithmetic operation with respect to both the set of adjustable parameters and a set of quantization parameters associated with the quantization of neural network parameters.

7. The computer-implemented method of claim 6, wherein the set of identified arithmetic operations comprises one or more of:
a multiplication operation;
an adding operation;
a clipping operation;
a rounding operation;
a left bit-shift operation; and
a right bit-shift operation.

8. The computer-implemented method of claim 6, wherein the set of quantization parameters for a given quantized neural network parameter comprises:
a quantization scale;
a zero point value; and
a calibrated upper bound value for the quantized neural network parameter.

9. The computer-implemented method of claim 8, wherein the set of constraints comprises a first quantization-scale equality constraint between the quantization scales of a set of input values of the neural network node and the quantization scale of an output of the neural network node.

10. The computer-implemented method of claim 8,
wherein the identified set of arithmetic operations comprises a set of addition operations; and
wherein the set of constraints comprises a second quantization-scale equality constraint between the two inputs of each addition operation within the set of identified addition operations.

11. The computer-implemented method of claim 6,
wherein the identified set of arithmetic operations comprises a set of bit-shift operations; and
wherein the set of constraints comprises a set of inequality constraints corresponding to size limits of a set of registers in the hardware device used to implement the set of identified bit-shift operations.

12. The computer-implemented method of claim 1, wherein solving the optimization problem comprises applying one of the following optimization techniques:
a linear optimization technique; and
a brute-force search technique.

13. An apparatus, comprising:
a processor; and
a storage device coupled to the processor, wherein the storage device storing instructions which, when executed by the processor, cause the processor to perform a method for minimizing quantization accuracy losses when implementing a neural network node on a hardware device, the method comprising:
identifying a set of adjustable parameters to be stored in the hardware device;
modeling the quantization of neural network parameters and output of the neural network node on the hardware device as an optimization problem by formulating at least 9 an objective function, wherein the objective function is a function of the set of adjustable parameters;
solving the optimization problem by identifying a set of values for the set of adjustable parameters that satisfies the objective function; and
program the hardware device by configuring the set of adjustable parameters with the set of identified values, thereby allowing the programmed hardware device to implement the neural network node with improved precision at an output of the neural network node.

14. The apparatus of claim 13, wherein formulating the optimization problem comprises:
formulating the objective function to minimize quantization accuracy losses in terms of a set of optimizable variables associated with the quantization of the set of neural network parameters; and
mapping the set of optimizable variables of the objective function to the set of adjustable parameters of the hardware device.

15. The apparatus of claim 14,
wherein the set of optimizable variables comprises a set of bit-shift variables associated with the quantization of the set of neural network parameters; and
wherein the set of adjustable parameters comprises a set of registers of the hardware device.

16. The apparatus of claim 15, wherein the set of bit-shift variables comprises a set of right bit-shift variables, and wherein formulating the objective function to minimize quantization accuracy losses in terms of the set of optimizable variables comprises minimizing a weighted sum of the set of right bit-shift variables.

17. The apparatus of claim 13,
wherein the optimization problem additionally comprises a set of constraints associated with the set of adjustable parameters; and
wherein solving the optimization problem comprises identifying the set of values for the set of adjustable parameters that satisfy the set of constraints.

18. A non-transitory computer readable storage medium storing instructions which, when executed by a processor, causes the processor to perform a method for minimizing quantization accuracy losses when implementing a neural network node on a hardware device, the method comprising:
one or more processors; and
a memory coupled to the one or more processors, wherein the memory storing instructions that, when executed by the one or more processors, cause the edge device to:
identifying a set of adjustable parameters to be stored in the hardware device;
modeling the quantization of neural network parameters and output of the neural 5 network node on the hardware device as an optimization problem by formulating at least an objective function, wherein the objective function is a function of the set of adjustable parameters;
solving the optimization problem by identifying a set of values for the set of adjustable parameters that satisfies the objective function; and
program the hardware device by configuring the set of adjustable parameters with the set of identified values, thereby allowing the programmed hardware device to implement the neural network node with improved precision at an output of the neural network node.

19. The non-transitory computer readable storage medium of claim 18, wherein formulating the optimization problem comprises:
formulating the objective function to minimize quantization accuracy losses in terms of a set of optimizable variables associated with the quantization of the set of neural network 4 parameters; and
mapping the set of optimizable variables of the objective function to the set of adjustable parameters of the hardware device.

20. The non-transitory computer readable storage medium of claim 18, wherein the optimization problem additionally comprises a set of constraints associated with the set of adjustable parameters; and
wherein solving the optimization problem comprises identifying the set of values for the set of adjustable parameters that satisfy the set of constraints.
